(19) United States
(12) Patent Application Publication
(10) Pub. No.: US 2023/0415929 A1
(43) Pub. Date: Dec. 28, 2023

(54) CHARGING SYSTEM AND METHOD FOR AIRBORNE CHARGING OF ELECTRICAL AIRCRAFT

(71) Applicant: Dr. Ing. h.c. F. Porsche Aktiengesellschaft, Stuttgart (DE)

(72) Inventor: Mark Foligno, Berlin (DE)

(73) Assignee: Dr. Ing. h.c. F. Porsche Aktiengesellschaft, Stuttgart (DE)

(21) Appl. No.: 18/137,605

(22) Filed: Apr. 21, 2023

(30) Foreign Application Priority Data
Jun. 27, 2022 (DE) 10 2022 115 939.6

(51) Int. Cl. B64U 50/34; B64D 27/24

(52) U.S. Cl. CPC B64U 50/34; B64U 2101/25; B64U 2201/20; B64D 27/24

(57) ABSTRACT

A charging system for electrical aircraft includes multiple charging drones distributed in an airspace. A respective charging drone is configured so as to be operated with a first type of fuel, wherein the respective charging drone carries a supply of a second type of fuel. The respective charging drone includes an energy converter, which is configured so as to provide from the supply of the second type of fuel an electrical power to be transmitted to an electrical aircraft located in the airspace. The charging system is configured so as to identify among the charging drones located in the airspace the one which demonstrates optimal criteria for the electrical aircraft and to prompt this charging drone to proceed to the electrical aircraft, carry out a charging operation, and fly back to its waiting position.

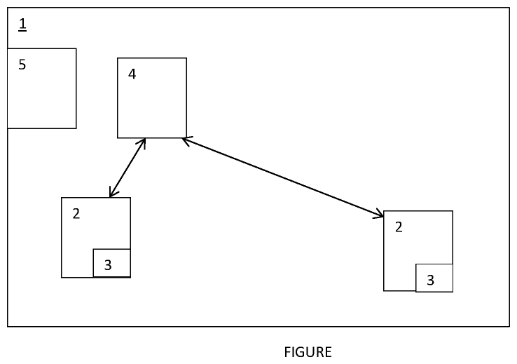

### CROSS-REFERENCE TO RELATED APPLICATION

This application claims priority to German Patent Application No. 10 2022 115 939.6, filed Jun. 27, 2022, the content of such application being incorporated by reference herein in its entirety.

### FIELD OF THE INVENTION

The present invention relates to an airborne charging system for electrical aircraft, as well as a method controlling the airborne charging system.

### BACKGROUND OF THE INVENTION

Airborne fueling allows for an extension of the range of an aircraft without having to land and re-start for fueling in a time-consuming manner. While fueling with fossil fuels is predominantly established in the military sector, with the rapidly increasing number of electrical aircraft, e.g. as transport drones for delivering packages, an airborne transmission of electrical energy is becoming increasingly important. This is all the more so true when extending the usage potential to the transport of people, where safety-relevant considerations, e.g. with regard to a reserve fuel level, have a higher priority. Charging possibilities in the air are therefore both time-saving, because they also increase the transport safety.

WO 2017/215200 A1, which is incorporated by reference herein, discloses a wirelessly chargeable, unmanned aircraft. To receive energy provided by a radiating apparatus stationed on the ground, the aircraft possesses a receiving apparatus on the fuselage.

US 2017/0297445 A1, which is incorporated by reference herein, describes an unmanned aircraft that is connectable to a further unmanned aircraft in order to increase the range via a docking apparatus. A docking method and a undocking method are also discussed for this purpose.

KR 10-1858244, which is incorporated by reference herein, discloses a charging apparatus for wirelessly charging an unmanned aircraft. The charging apparatus is connectable to the aircraft in the air.

US 2019/0047701 A1, which is incorporated by reference herein, discusses a charging system for recharging unmanned aircraft in the air. The charging system monitors a respective state of charge of the aircraft and provides an airborne charging of a respective aircraft in order to continue its flight.

### SUMMARY OF THE INVENTION

In light of this background, a problem addressed by the present invention is to provide an airborne charging system for electrical aircraft that charges an electrical aircraft during flight. Further, a method controlling the charging system is to be provided.

### BRIEF DESCRIPTION OF THE DRAWING

The sole FIGURE depicts a schematic representation of an airborne charging system for electrical aircraft that charges an electrical aircraft during flight.

### DETAILED DESCRIPTION OF THE INVENTION

To solve the aforementioned problem, a charging system for electrical aircraft is proposed, wherein the charging system comprises multiple charging drones distributed in an airspace. A respective charging drone is configured so as to operate with a first type of fuel and to carry a supply of a second type of fuel. The respective charging drone comprises an energy converter configured so as to provide from the supply of the second type of fuel an electrical power to be transmitted to an electrical aircraft located in the airspace. The charging system is configured so as to identify among the charging drones located in the airspace the charging drone that demonstrates optimal criteria for the electrical aircraft and to prompt the charging drone to proceed to the electrical aircraft, carry out a charging operation, and fly back to its waiting position.

The electrical aircraft is, in particular, a means of transport for carrying people. Electrical aircraft used for passenger transport are also abbreviated as “e-VTOL”, which means “electric vertical take-off and landing aircraft,” as they are designed to take off and land perpendicularly and are therefore independent of traffic conditions on the ground, especially in dense urban environments. The charging system according to aspects of the invention advantageously increases a range of the electrical aircraft or increases a safety reserve for a flight duration.

The charging drones of the charging system according to aspects of the invention are autonomously controlled, i.e. a computer program running on a central computing unit controls all charging drones, which remain in radio contact with that central computing unit. However, it is also conceivable that each charging drone will have its own computing unit, and the computer program running thereon will prompt all charging drones of the charging system according to aspects of the invention to communicate their respective position and fuel/charging capacity via a respective radio contact and thus to act as a swarm in order to form the charging system according to aspects of the invention.

In a configuration of the charging system according to aspects of the invention, a respective type of fuel is selected from the following list: jet fuel, hydrogen, electrochemical energy stored for example in a battery, electrostatic energy stored for example in a capacitor. It is conceivable that a respective charging drone will have a solar panel through which electrical energy is generated and stored in electrical energy reservoirs.

The first type of fuel is selected according to a type of drive selected for the particular charging drone, such as a jet engine with conventional fuel or propellers on an electric machine, wherein the electrical energy originates from hydrogen fuel cells or from the discharging of batteries. The second type of fuel also varies depending on how the respective power converter being carried along generates the electrical power for charging the electrical aircraft. It is conceivable that the first type of fuel and the second type of fuel are the same and also stored in a same reservoir so that a respective controller monitors to ensure that the respective charging drone, when the electrical aircraft is charged, empties its reservoir no more than is necessary for a safe return to a base station or to reach a further charging drone for its own charging.

In a further configuration of the charging system according to aspects of the invention, the criteria for selecting the charging drone are selected from the following list: distance to the electrical aircraft, charging status of the electrical aircraft, required charging energy of the electrical aircraft, range of the charging drone based on the first type of fuel, charging capacity based on the second type of fuel.

In yet another configuration of the charging system according to aspects of the invention, the charging system comprises an artificial intelligence (abbreviated as “AI”). The artificial intelligence is configured so as to evaluate the criteria for identifying the charging drone that demonstrates the optimal criteria for the electrical aircraft. With the aid of such an AI-based logistics system, the charging drone that is most suitable to recharge the electrical aircraft at a time of a recharging request by an electrical aircraft is identified and entrusted with the task of refueling/recharging in the air.

In yet another configuration of the charging system according to aspects of the invention, the artificial intelligence is configured so as to determine an optimal distribution of the waiting positions. Such an optimal distribution can be, for example, a uniform distribution over the airspace, but also a concentration of charging drones along preferred flight paths of the electrical aircraft and/or positions and/or regions of frequent recharging requests of the electrical aircraft.

Further, a method for airborne charging of electrical aircraft is described, wherein multiple charging drones are distributed in an airspace. A respective charging drone is operated with a first type of fuel and is equipped with a supply of a second type of fuel. A power converter is arranged in the respective charging drone, wherein an electrical power to be transmitted to an electrical aircraft located in the airspace is provided by the power converter from the supply of the second type of fuel. Among the charging drones located in the airspace, the charging drone that demonstrates optimal criteria for the electrical aircraft is identified. This charging drone is prompted to proceed to the electrical aircraft in order to carry out a charging operation and then fly back to its waiting position.

In one embodiment of the method according to aspects of the invention, a respective fuel is selected from the following list: jet fuel, hydrogen, electrochemical energy, electrostatic energy.

In a further embodiment of the method according to aspects of the invention, the criteria for selecting the charging drone are selected from the following list: distance to the electrical aircraft, charging status of the electrical aircraft, required charging energy of the electrical aircraft, range of the charging drone based on the first type of fuel, charging capacity based on the second type of fuel.

In yet another embodiment of the method according to aspects of the invention, the criteria for identifying the charging drone demonstrating the optimal criteria for the electrical aircraft are evaluated by an artificial intelligence.

In yet another embodiment of the method according to aspects of the invention, an optimal distribution of the waiting positions is determined by the artificial intelligence.

Turning now to the sole FIGURE, a charging system 1 for electrical aircraft is shown, wherein the charging system 1 comprises multiple charging drones 2 distributed in an airspace, wherein a respective charging drone 2 is configured so as to be operated with a first type of fuel and carry a supply of a second type of fuel, wherein the respective charging drone comprises an energy converter 3, which is configured so as to provide from the supply of the second type of fuel an electrical power to be transmitted to an electrical aircraft 4 located in the airspace, wherein the charging system 1 is configured so as to identify among the charging drones 2 located in the airspace the one which demonstrates optimal criteria for the electrical aircraft and to prompt this charging drone to proceed to the electrical aircraft 4, carry out a charging operation, and fly back to its waiting position. The charging system comprises an artificial intelligence 5, wherein the artificial intelligence is configured so as to evaluate the criteria for identifying the charging drone 2 which demonstrates the optimal criteria for the electrical aircraft 4.

It will be understood that the artificial intelligence as well as the operational steps described herein are performed by computers or processors upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computers or processors described herein described herein is implemented in software code or instructions which are tangibly stored on a tangible computer readable medium. Upon loading and executing such software code or instructions by the computers or processors, the computers or processors may perform any of the functionality of the computers or processors described herein, including any steps of the methods described herein.

The term “software code” or “code” used herein refers to any instructions or set of instructions that influence the operation of computers or processors. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

It goes without saying that the aforementioned features can be used not only in the respectively specified combination, but also in other combinations or on their own, without leaving the scope of the present invention.

What is claimed is:

1. A charging system for electrical aircraft, wherein the charging system comprises:
multiple charging drones distributed in an airspace, wherein each charging drone is configured so as to be operated with a first type of fuel and carry a supply of a second type of fuel,
wherein each charging drone comprises an energy converter, which is configured so as to provide from the supply of the second type of fuel an electrical power to be transmitted to an electrical aircraft located in the airspace, and
wherein the charging system is configured so as to (i) identify one charging drone, from among the charging drones located in the airspace, that demonstrates optimal criteria for the electrical aircraft and (ii) prompt the identified charging drone to (a) proceed to the electrical aircraft, (b) carry out a charging operation, and (c) fly back to a waiting position.

2. The charging system according to claim 1, wherein a respective type of fuel is selected from the following list: jet fuel, hydrogen, electrochemical energy, and electrostatic energy.

3. The charging system according to claim 1, wherein criteria for selection of the one charging drone are selected from the following list: distance to the electrical aircraft, charging status of the electrical aircraft, required charging energy of the electrical aircraft, range of the charging drone based on the first type of fuel, and charging capacity based on the second type of fuel.

4. The charging system according to claim 1, wherein the charging system comprises an artificial intelligence, wherein the artificial intelligence is configured so as to evaluate the criteria for identifying the one charging drone which demonstrates the optimal criteria for the electrical aircraft.

5. The charging system according to claim 4, wherein the artificial intelligence is configured so as to determine an optimal distribution of the waiting positions.

6. A method for airborne charging of electrical aircraft, wherein multiple charging drones are distributed in an airspace, wherein each charging drone operates using a first type of fuel, wherein each charging drone is equipped with a supply of a second type of fuel, wherein a power converter is arranged in each charging drone, wherein an electrical power to be transmitted to an electrical aircraft located in the airspace is provided by the energy converter from the supply of the second type of fuel, said method comprising:
identifying one charging drone from among the multiple charging drones located in the airspace based upon optimal criteria for the electrical aircraft, and
prompting said one charging drone to proceed to the electrical aircraft, carry out a charging operation, and fly back to a waiting position.

7. The method according to claim 6, wherein a respective type of fuel is selected from the following list: jet fuel, hydrogen, electrochemical energy, and electrostatic energy.

8. The method according to claim 6, wherein the criteria for selection of the charging drone are selected from the following list: distance to the electrical aircraft, charging status of the electrical aircraft, required charging energy of the electrical aircraft, range of the charging drone based on the first type of fuel, and charging capacity based on the second type of fuel.

9. The method according to claim 6, wherein the criteria for identifying the charging drone demonstrating the optimal criteria for the electrical aircraft are evaluated by way of artificial intelligence.

10. The method according to claim 9, wherein an optimal distribution of the waiting positions is determined by the artificial intelligence.
